(19) United States
(12) Patent Application Publication
(10) Pub. No.: US 2024/0057031 A1
(43) Pub. Date: Feb. 15, 2024

(54) TERMINAL, BASE STATION, AND TRANSMISSION METHOD

(71) Applicant: NTT DOCOMO, INC., Tokyo (JP)

(72) Inventors: Masaya Okamura, Chiyoda-ku, Tokyo (JP); Tomoya Ohara, Chiyoda-ku, Tokyo (JP); Hiroki Harada, Chiyoda-ku, Tokyo (JP)

(73) Assignee: NTT DOCOMO, INC., Tokyo (JP)

(21) Appl. No.: 18/280,373

(22) PCT Filed: Mar. 17, 2021
(86) PCT No.: PCT/JP2021/010904

§ 371 Date: Sep. 5, 2023

(51) Int. Cl. H04W 68/00; H04L 5/00

(52) U.S. Cl. CPC H04W 68/00; H04L 5/0051

(57) ABSTRACT

A terminal is disclosed including a reception unit configured to receive, from a base station, configuration information on a reference signal of uplink for positioning in a non-connected state; and a transmission unit configured to transmit the reference signal based on the configuration information in the non-connected state. In other aspects, another terminal, a base station, and a transmission method are also disclosed.

### FIELD OF THE INVENTION

The present invention relates to a terminal and a base station in a wireless communication system.

### BACKGROUND ART

In 3GPP (3rd Generation Partnership Project), a wireless communication system (hereinafter referred to as “NR”) called 5G or NR (New Radio) is being studied in order to realize further increase of system capacity, further increase of data transmission speed, and further decrease of delay in the wireless section. In 5G, various wireless technologies and network architectures are being studied in order to achieve a throughput of 10 Gbps or higher and to satisfy the requirement that delay in the wireless section should be 1 ms or less.

Also, “Positioning” for performing positioning using a reference signal or the like has been studied. As a positioning scheme, for example, there is a scheme in which a terminal transmits an uplink (UL) reference signal (UL-PRS (Positioning Reference Signal)) to a plurality of base stations and performs positioning based on a time difference between reception timings.

### PRIOR ART DOCUMENT

### Non Patent Literature

[Non-Patent Document 1] 3GPP TS 38.214 V16.4.0 (2020-12)
[Non-Patent Document 2] 3GPP TS 38.331 V16.3.1 (2021-01)

### SUMMARY OF THE INVENTION

### Problems to be Solved by the Invention

Regarding the UL-PRS, in the related art disclosed in Non-Patent Documents 1, 2, and the like, SRS (Sounding Reference Signal) for Positioning is supported. However, in the related art, since positioning operation is supported only in RRC_CONNECTED state, in order for the terminal to perform a positioning operation such as transmitting the SRS for Positioning, it is necessary to set the terminal to the RRC_CONNECTED state each time and it takes time to perform positioning.

Even if the terminal tries to perform a positioning operation in an RRC_INACTIVE state, since an UL signal for positioning that can be used in the RRC_INACTIVE state is not defined in the related art, the terminal cannot perform a positioning operation by transmitting an UL signal in the RRC_INACTIVE state. This problem occurs not only in the RRC_INACTIVE state but also in an RRC_IDLE state. The RRC_INACTIVE state and the RRC_IDLE state are collectively referred to as a “non-connected state”.

The present invention has been made in view of the above circumstances, and an object thereof is to provide a technique that enables a terminal to transmit an UL signal for positioning in a non-connected state.

### Means for Solving the Problem

According to the disclosed technique, there is provided a terminal including:
a reception unit configured to receive, from a base station, configuration information on a reference signal of uplink for positioning in a non-connected state; and
a transmission unit configured to transmit the reference signal based on the configuration information in the non-connected state.

### Effects of the Invention

According to the disclosed technology, a terminal can transmit an UL signal for positioning in a non-connected state.

### BRIEF DESCRIPTION OF THE DRAWINGS

FIG. 1 is a diagram for explaining a wireless communication system according to an embodiment of the present invention;

FIG. 2 is a diagram for explaining a wireless communication system according to an embodiment of the present invention;

FIG. 3 is a diagram for explaining a basic operation of the wireless communication system according to an embodiment of the present invention;

FIG. 4 is a diagram for explaining an operation example in Example 1-1;

FIG. 5 is a diagram for explaining an operation example in Example 1-2;

FIG. 6 is a diagram showing an example of a functional configuration of a base station 10 according to an embodiment of the present invention;

FIG. 7 is a diagram showing an example of a functional configuration of a terminal 20 according to an embodiment of the present invention;

FIG. 8 is a diagram illustrating an example of a hardware configuration of the base station 10 or the terminal 20 according to an embodiment of the present invention.

### DETAILED DESCRIPTION OF THE INVENTION

Hereinafter, embodiments of the present invention will be described with reference to the drawings. It should be noted that the embodiments described below are merely examples, and embodiments to which the present invention is applied are not limited to the following embodiments.

Although it is assumed that the wireless communication system according to the embodiment of the present invention is an NR system, the technique according to the present invention is applicable not only to NR but also to other systems.

Also, in the following embodiments, description will be given using RRC_INACTIVE state as an example of the “non-connected state”, but the same operation is possible even if RRC_INACTIVE state is replaced with RRC_IDLE state.

Also, in the examples described below, SRS, SRS for positioning, and PRACH preamble are given as examples of UL-PRS, but these are examples, and signals other than these may be used as the UL-PRS described below.

(System Configuration)

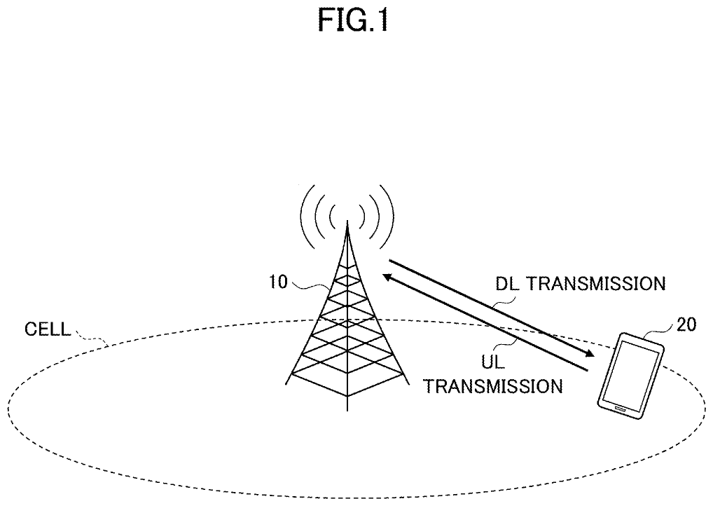

FIG. 1 is a diagram illustrating a wireless communication system according to an embodiment of the present invention. The wireless communication system in an embodiment of the present invention includes a base station 10 and a terminal 20, as shown in FIG. 1. In FIG. 1, one base station 10 and one terminal 20 are shown, but this is an example and a plurality of base stations 10 and a plurality of terminals 20 may be provided. For example, a plurality of base stations serving as transmission destinations of an UL-PRS transmitted by the terminal 20 may be provided.

The base station 10 is a communication device that provides one or more cells and performs wireless communication with the terminal 20. The physical resources of the radio signal are defined in the time domain and the frequency domain, the time domain may be defined in OFDM symbols, and the frequency domain may be defined in subcarriers or resource blocks. TTI (Transmission Time Interval) in the time domain may be a slot, or TTI may be a subframe.

The base station 10 can provide carrier aggregation for communicating with the terminal 20 by aggregating a plurality of cells (a plurality of CCs (component carriers)). Carrier aggregation uses one PCell (primary cell) and one or more SCells (secondary cells).

The base station 10 transmits synchronization signals and system information to the terminal 20. The synchronization signals are, for example, NR-PSS and NR-SSS. System information is transmitted, for example, by NR-PBCH or PDSCH, and is also called broadcast information. As shown in FIG. 1, the base station 10 transmits a control signal or data in DL (Downlink) to the terminal 20 and receives a control signal or data in UL (Uplink) from the terminal 20. Here, what is transmitted by a control channel such as PUCCH and PDCCH is called a control signal, and what is transmitted by a shared channel such as PUSCH and PDSCH is called data. But, this is an example.

The terminal 20 is a communication device with a wireless communication function, such as a smartphone, a cellular phone, a tablet, a wearable terminal, and a communication module for M2M (Machine-to-Machine). As shown in FIG. 1, the terminal 20 utilizes various communication services provided by a wireless communication system by receiving a control signal or data in DL from the base station 10 and transmitting a control signal or data in UL to the base station 10. The terminal 20 may be called a UE, and the base station 10 may be called a gNB.

The terminal 20 can provide carrier aggregation for communicating with the base station 10 by aggregating a plurality of cells (a plurality of CCs (component carriers)). Carrier aggregation uses one PCell (primary cell) and one or more SCells (secondary cells). Also, a PUCCH-SCell with a PUCCH may be used.

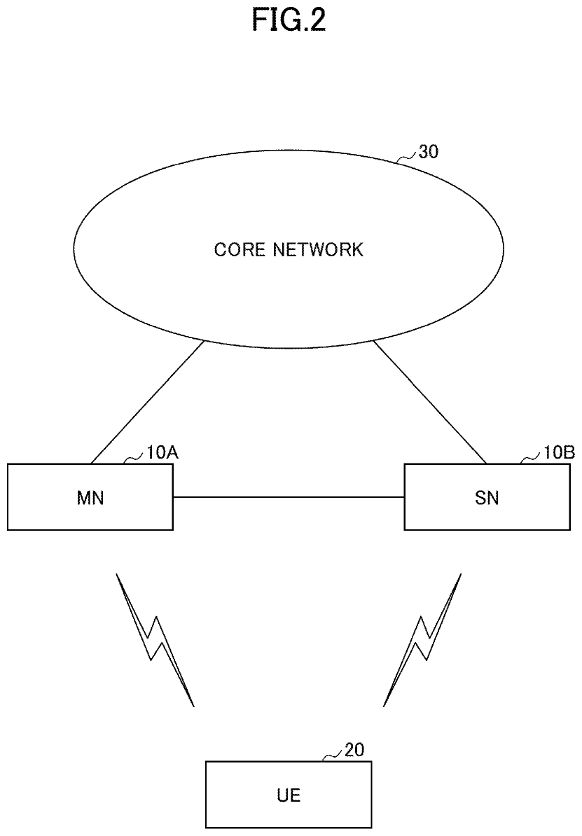

FIG. 2 shows an example of a configuration of a wireless communication system when DC (Dual connectivity) is executed. As shown in FIG. 2, a base station 10A serving as an MN (Master Node) and a base station 10B serving as an SN (Secondary Node) are provided. The base station 10A and the base station 10B are each connected to a core network. The terminal 20 can communicate with both the base station 10A and the base station 10B.

The cell group provided by the base station 10A that is an MN is called MCG (Master Cell Group), and the cell group provided by the base station 10B that is an SN is called SCG (Secondary Cell Group). In addition, in DC, the MCG is composed of one Pell and one or more SCell, and the SCG is composed of one PSCell (Primary SCell) and one or more SCell.

The processing operation according to this embodiment may be performed in the system configuration shown in FIG. 1, in the system configuration shown in FIG. 2, or may be performed in other system configurations.

### Basic Operation Example

In the present embodiment, it is assumed that the terminal 20 performs a positioning operation in an RRC_INACTIVE state. The positioning operation of the terminal 20 in the present embodiment is to transmit an UL-PRS.

As a premise of performing a positioning operation in an RRC_INACTIVE state, the terminal 20 may report a UE capability (UE capability information) indicating presence or absence of a capability of performing a positioning operation in the RRC_INACTIVE state to the base station 10.

The UE capability information may include any one, two, or all of the following three pieces of information. Further, information other than the following three pieces of information may be included.
Presence or absence of support of positioning function in RRC_INACTIVE state
Supported PRS type (example: PRACH preamble)
Supported PRS configuration parameter (example: periodic/semi-persistent/aperiodic)

It may be assumed that the above information is reported to the NW (the base station 10) for each UL-PRS type supported by the terminal 20.

The terminal 20 may be indicated by the base station 10 to enable or disable positioning in the RRC_INACTIVE state by an RRC signal, a MAC-CE, or a DCI. This “indication” may be “configure” in the case of RRC, “update” in the case of MAC-CE, and “indicate” in the case of DCI. Hereinafter, “RRC/MAC-CE/DCI” means an RRC signal, a MAC-CE, or a DCI.

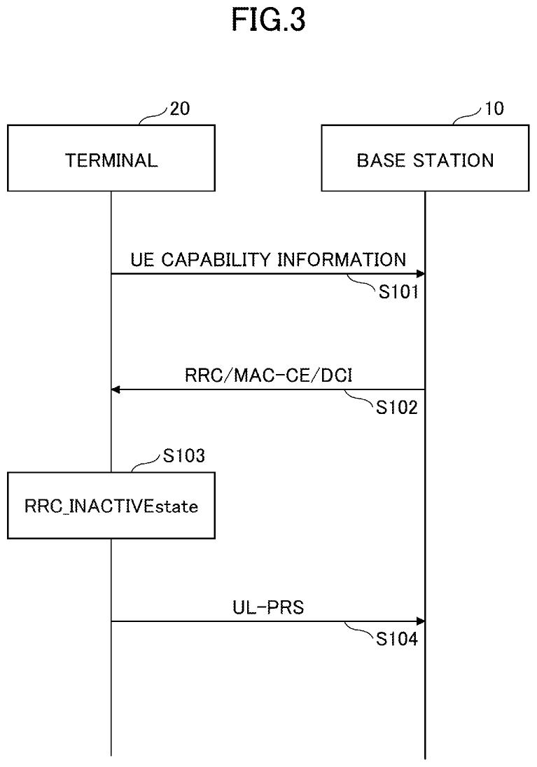

A basic operation example will be described with reference to FIG. 3. It is assumed that the initial state of the terminal 20 is an RRC_CONNECTED state.

In S101, the terminal 20 transmits UE capability information to the base station 10. As described above, the UE capability information includes, for example, information indicating that “a positioning function is supported in an RRC_INACTIVE state and PRACH preamble is supported as UL-PRS”.

In S102, the base station 10 indicates to the terminal 20 availability of positioning in the RRC_INACTIVE state by RRC/MAC-CE/DCI. Here, it is assumed that “positioning is available” is indicated.

In S103, the terminal 20 enters the RRC_INACTIVE state. In S104, the terminal 20 transmits an UL-PRS.

Hereinafter, Example 1 and Example 2 will be described for details of the UL-PRS used in the RRC_INACTIVE state. Example 1 includes Example 1-1 and Example 1-2, and Example 2 includes Example 2-1 and Example 2-2. Example 1-1, Example 1-2, Example 2-1, and Example 2-2 can be implemented in any combination. In the following description, SRS, SRS for positioning, and PRACH preamble are assumed as the UL-PRS. However, these are examples, and signals other than these may be assumed as the UL-PRS. The contents described in the following Examples 1 and 2 can be applied to signals other than the SRS, the SRS for positioning, and the PRACH preamble.

### Example 1

### Example 1-1

In the Example 1-1, as an UL-PRS that can be used by the terminal 20 in the RRC_INACTIVE state, any one or more of an SRS, an SRS for positioning, and a PRACH preamble are defined in the specification.

As configuration information of the UL-PRS that can be used by the terminal 20 in the RRC_INACTIVE state, one or more pieces of configuration information of an SRS, an SRS for positioning, and a PRACH preamble may be notified from the base station 10 to the terminal 20 by RRC/MAC-CE/DCI.

Note that any two or more of the SRS, the SRS for positioning, and the PRACH preamble are: “SRS and SRS for positioning”, “SRS and PRACH preamble”, “SRS for positioning and PRACH preamble”, or “SRS and SRS for positioning and PRACH preamble”. Also, “SRS” refers to an SRS that is not “SRS for positioning”.

Hereinafter, each of a case in which one UL-PRS is defined/notified and a case in which a plurality of UL-PRSs are defined/notified will be described.

<Case where One UL-PRS is Defined/Notified>

The terminal 20 assumes that a type (example: SRS for positioning) of the UL-PRS transmitted in the RRC_INACTIVE state, the resource configuration, or both of them are configured by the base station 10 by RRC.

Based on the above assumption, for example, the terminal 20 receives the type and the resource configuration of an UL-PRS transmitted in the RRC_INACTIVE state from the base station 10, and transmits the UL-PRS based on the received information.

The resource configuration is, for example, a PRACH root sequence index, an SRS resource set, an SRS resource, or the like.

Alternatively, the type (example: SRS for positioning) of the UL-PRS transmitted in the RRC_INACTIVE state, the resource configuration, or both of them may be defined in the specification, and the terminal 20 may transmit the UL-PRS according to the description of the specification. In this case, for example, the control unit of the terminal 20 holds configuration information based on the description of the specification, and the terminal 20 transmits the UL-PRS based on the configuration information.

In addition, the terminal 20 may assume that enable/disable of the UL-PRS configured in RRC (or defined in the specification) is configured in RRC. Based on this assumption, the terminal 20 receives “enable” or “disable” transmitted from the base station 10 by RRC, transmits the configured UL-PRS if “enable” is received, and does not transmit the configured UL-PRS if “disable” is received.

The terminal 20 may assume that the UL-PRS configured by RRC (or defined in the specification) is activated/deactivated by a MAC-CE. Based on this assumption, the terminal 20 receives an activate instruction or a deactivate instruction transmitted by the MAC-CE from the base station 10, performs transmission of the configured UL-PRS if the instruction is activate, and does not perform transmission of the configured UL-PRS if the instruction is deactivate.

The terminal 20 may assume that the UL-PRS configured by RRC (or defined in the specification) is triggered by a DCI. Based on this assumption, the terminal 20 transmits the UL-PRS when receiving a trigger transmitted by the DCI from the base station 10.

Furthermore, the terminal 20 may assume that update of the UL-PRS configured in RRC (or defined in the specification) is configured by RRC. Based on this assumption, the terminal 20 receives update information transmitted from the base station 10 by RRC, and transmits the updated UL-PRS.

The terminal 20 may assume that the UL-PRS configured by RRC (or defined in the specification) is updated by a MAC-CE. Based on this assumption, the terminal 20 receives update information transmitted by the MAC-CE from the base station 10 and transmits the updated UL-PRS.

The terminal 20 may assume that update of the UL-PRS configured by RRC (or defined in the specification) is indicated (instructed) by a DCI. Based on this assumption, when the terminal 20 receives information (update indication information) of “indicate” transmitted by the DCI from the base station 10, the terminal 20 transmits the updated UL-PRS.

<A Case where Multiple UL-PRSs are Defined/Notified>

Next, a case in which a plurality of UL-PRSs are defined/notified will be described. As described above, the “plurality of UL-PRSs” are, for example, “SRS and SRS for positioning”, “SRS and PRACH preamble”, “SRS for positioning and PRACH preamble”, or “SRS, SRS for positioning and PRACH preamble”.

The terminal 20 assumes that types (example: SRS for positioning and PRACH preamble), resource configurations, or both of them of a plurality of UL-PRSs to be transmitted in an RRC_INACTIVE state are configured by the base station 10 by RRC.

Based on the above assumption, for example, the terminal 20 receives types and resource configurations of the plurality of UL-PRSs to be transmitted in the RRC_INACTIVE state from the base station 10, determines one UL-PRS to be used from the plurality of UL-PRSs based on the received information, and transmits the determined UL-PRS.

As described above, the resource configurations are, for example, a PRACH root sequence index, an SRS resource set, an SRS resource, and the like.

Alternatively, types (example: SRS for positioning and PRACH preamble), resource configurations, or both of them of a plurality of UL-PRSs to be transmitted in the RRC_INACTIVE state may be defined in the specification, and the terminal 20 may transmit an UL-PRS according to the description of the specification. In this case, for example, the control unit of the terminal 20 holds configuration information based on the description of the specification, and the terminal 20 transmits an UL-PRS based on the configuration information.

The terminal 20 may assume that enable/disable for any one or a plurality of UL-PRSs among a plurality of UL-PRSs configured in RRC (or defined in the specification) is configured in RRC. Based on this assumption, the terminal 20 receives enable or disable transmitted from the base station 10 through RRC. For example, when the terminal 20 receives enable for one specific UL-PRS among the plurality of configured UL-PRSs, the terminal 20 transmits the UL-PRS.

Also, the terminal 20 may assume that any one or a plurality of UL-PRSs among a plurality of UL-PRSs configured by RRC (or defined by a specification) are activated/deactivated by a MAC-CE. Based on this assumption, the terminal receives an activate instruction or a deactivate instruction transmitted by a MAC-CE from the base station 10. For example, when the terminal 20 receives activate for one specific UL-PRS among a plurality of configured UL-PRSs, the terminal 20 transmits the UL-PRS.

Also, the terminal 20 may assume that any one or more UL-PRSs among a plurality of UL-PRSs configured by RRC (or defined by a specification) are triggered by a DCI. Based on this assumption, the terminal 20 receives a trigger transmitted by the DCI from the base station 10. For example, when the terminal 20 receives a trigger for one specific UL-PRS among a plurality of configured UL-PRSs, the terminal 20 transmits the UL-PRS.

Also, the terminal 20 may assume that update of any one or a plurality of UL-PRSs among a plurality of UL-PRSs configured in RRC (or defined in the specification) is configured by RRC. Based on this assumption, the terminal 20 receives update information transmitted from the base station 10 by RRC. For example, in a case where the terminal 20 receives update information for one specific UL-PRS among a plurality of configured UL-PRSs, when the terminal 20 transmits the UL-PRS, the terminal 20 transmits the updated UL-PRS.

Also, the terminal 20 may assume that any one or more UL-PRSs among a plurality of UL-PRSs configured by RRC (or defined by a specification) are updated by a MAC-CE. Based on this assumption, the terminal 20 receives update information transmitted by the MAC-CE from the base station 10. For example, in a case where the terminal 20 receives update information for a specific one UL-PRS among a plurality of configured UL-PRSs through the MAC-CE, when the terminal 20 transmits the UL-PRS, the terminal 20 transmits the updated UL-PRS.

Also, the terminal 20 may assume that updating of any one or more UL-PRSs among a plurality of UL-PRSs configured by RRC (or defined by a specification) is indicated by a DCI. Based on this assumption, the terminal 20 receives information (update information) of “indicate” transmitted by a DCI from the base station 10. For example, in a case where the terminal 20 receives information (update information) for one specific UL-PRS among the plurality of configured UL-PRSs, the terminal 20 transmits the updated UL-PRS for the UL-PRS.

<Information Notification Method for a Plurality of UL-PRSs>

In a case where the terminal 20 assumes that the terminal 20 receives configuration information (type, resource information, and the like) for a plurality of UL-PRSs (example: SRS for positioning and PRACH preamble), the terminal 20 may assume that configuration information for each UL-PRS is notified from the base station 10, or may assume that configuration information common to all (or some) of the plurality of UL-PRSs is notified from the base station 10.

In a case where it is assumed that the terminal 20 is notified of the configuration information for each of the UL-PRSs from the base station 10, for example, when a plurality of UL-PRSs are SRS for positioning and PRACH preamble, the base station 10 transmits configuration information of the SRS for positioning and configuration information of the PRACH preamble to the terminal 20, and the terminal 20 receives them.

In a case where the terminal 20 is assumed to be notified of configuration information common to all of a plurality of UL-PRSs from the base station 10, for example, if the plurality of UL-PRSs are SRS for positioning and SRS, the base station 10 transmits configuration information common to the SRS for positioning and the SRS to the terminal 20, and the terminal 20 receives this information.

Also, predetermined information may be notified for each type of UL-PRS. For example, in a case where UL-PRS type=PRACH preamble, only “periodic” may be notified from the base station 10 to the terminal 20 as the configuration information of the transmission method. On the other hand, for example, in a case where UL-PRS type=SRS for positioning, one of “periodic” and “aperiodic” may be notified as configuration information of the transmission method.

<Method for Determining UL-PRS to be Used in a Case where a Plurality of UL-PRSs are Specified/Notified>

In a case where a plurality of UL-PRSs are defined/notified, as a method of determining an UL-PRS to be used by the terminal 20, for example, there are the following option 1 and option 2.

<Option 1>

The terminal 20 determines an UL-PRS to be transmitted in an RRC_INACTIVE state based on a RACH occasion period (example: RACH transmission interval) or RACH config (example preamble format).

For example, the terminal 20 uses a PRACH preamble as an UL-PRS when the RACH transmission interval (RACH transmission cycle) is less than T [msec] (or T [msec] or less or T [msec] or more), and otherwise uses an SRS for positioning as the UL-PRS. T [msec] may be defined in the specification or may be notified from the base station 10 to the terminal 20 by RRC/MAC-CE/DCI.

By using the PRACH preamble as the UL-PRS when the RACH transmission interval (RACH transmission cycle) is less than T [msec], for example, it is possible to receive the UL-PRS with high frequency on the NW side that performs positioning calculation, and thus it is possible to perform more accurate positioning.

In a case where an UL-PRS to be transmitted in an RRC_INACTIVE state is determined based on a RACH config, for example, when a specific preamble format is configured by the base station 10, the PRACH preamble according to the specific preamble format is used as the UL-PRS. Which preamble format is the specific preamble format may be defined in the specification or may be notified from the base station 10 to the terminal 20 by RRC/MAC-CE/DCI.

<Option 2>

The terminal 20 may determine a signal (example: SRS for positioning) other than the PRACH preamble as an UL-PRS to be transmitted in an RRC_INACTIVE state outside the RACH occasion.

The above-mentioned RACH occasion may be a time resource for transmitting the PRACH preamble, a frequency resource for transmitting the PRACH preamble, or a time-frequency resource for transmitting the PRACH preamble.

For example, in a case where a PRACH preamble and an SRS for positioning are configured as a plurality of available UL-PRSs in the terminal 20, it is assumed that the X-th slot that arrives periodically is configured as a RACH occasion. In this case, for example, the terminal 20 uses the PRACH preamble as the UL-PRS in the X-th slot and uses the SRS for positioning as the UL-PRS in slots other than the X-th slot.

### Sequence Example

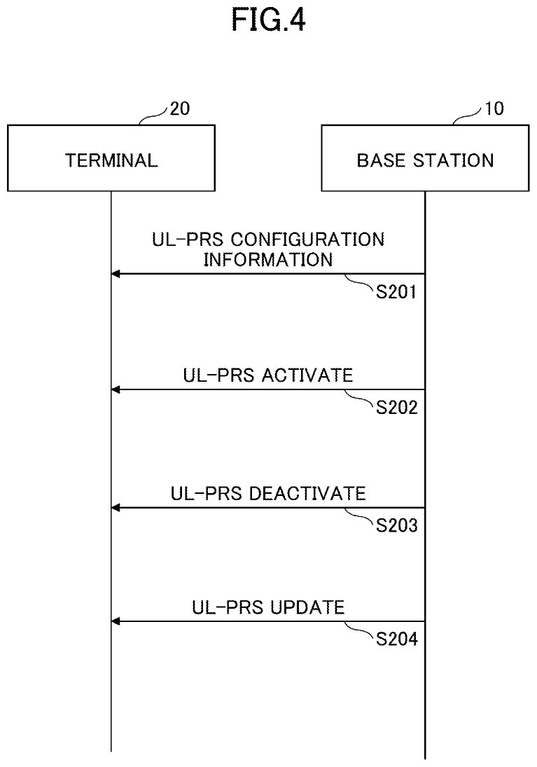

An example of an operation sequence in the Example 1-1 will be described with reference to FIG. 4. Here, it is assumed that activate, deactivate, and update are performed by a MAC-CE. In S201, the base station 10 transmits UL-PRS configuration information to the terminal 20. Here, as an UL-PRS, an UL-PRS_A is configured.

In S202, the base station 10 activates the UL-PRS_A to the terminal 20 by a MAC-CE. Thereafter, the terminal 20 transmits the UL-PRS A in a predetermined cycle designated by, for example, the configuration information.

In S203, the base station 10 deactivates the UL-PRS_A for the terminal 20 by a MAC-CE. Thereafter, the terminal 20 stops transmission of the UL-PRS_A.

In S204, the base stations 10 transmits update information of the UL-PRS_A to the terminal 20 by a MAC-CE. For example, if the update information is information of a cycle (period) after the update, the terminal 20 executes transmission at the cycle after the update when transmitting the UL-PRS_A.

According to the Example 1-1, since positioning can be performed in the RRC_INACTIVE state, a delay in acquiring position information is reduced. This effect is the same for the other Examples. Further, according to the Example 1-1, the UL-PRS transmitted in the RRC_INACTIVE state can be switched between a plurality of types of signals (example: RACH preamble and SRS for pos).

### Example 1-2

Next, Example 1-2 will be described. In the Example 1-2, the terminal 20 assumes that an UL-PRS transmitted in an RRC_INACTIVE state is configured separately from UL-PRS configuration used in an RRC_CONNECTED state. Alternatively, the terminal 20 assumes that the UL-PRS configuration used in the RRC_CONNECTED state is applied to the UL-PRS transmitted in the RRC_INACTIVE state.

The terminal 20 may assume that whether the UL-PRS transmitted in the RRC_INACTIVE state is configured separately from the UL-PRS configuration used in the RRC_CONNECTED state or whether the UL-PRS configuration used in the RRC_CONNECTED state is applied to the UL-PRS transmitted in the RRC_INACTIVE state is notified from the base station 10 by RRC/MAC-CE/DCI.

The configuration assumed above is, for example, a PRACH root sequence index, an SRS resource set, an SRS resource, or the like.

In a case where the terminal 20 assumes that the UL-PRS transmitted in the RRC_INACTIVE state is configured separately from the UL-PRS configuration used in the RRC_CONNECTED state, for example, the terminal 20 receives configuration information of the UL-PRS used in the RRC_CONNECTED state from the base station 10, and separately receives configuration information of the UL-PRS transmitted in the RRC_INACTIVE state from the base station 10.

In a case where it is assumed that the terminal 20 applies the UL-PRS configuration used in the RRC_CONNECTED state to the UL-PRS transmitted in the RRC_INACTIVE state, for example, the terminal 20 receives configuration information of the UL-PRS used in the RRC_CONNECTED state from the base station 10 and transmits the UL-PRS in the RRC_CONNECTED state and transmits the UL-PRS in the RRC_INACTIVE state based on the configuration information.

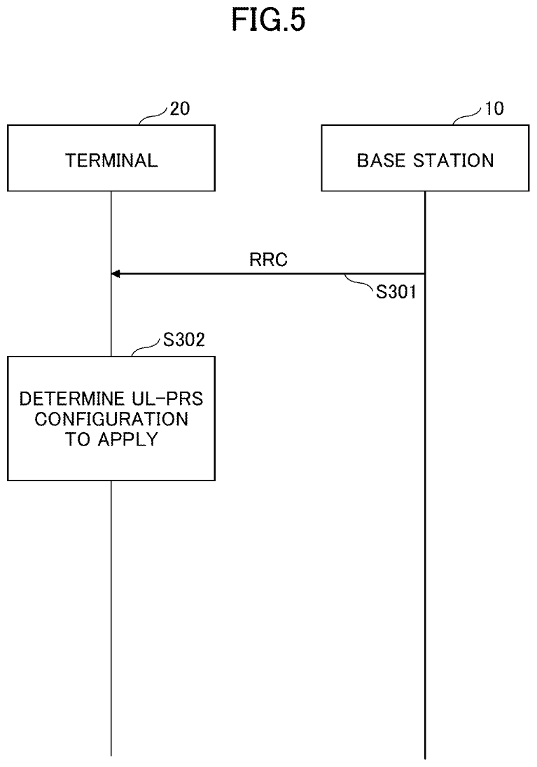

FIG. 5 illustrates a sequence example in a case where it is assumed that whether the UL-PRS transmitted by the terminal 20 in the RRC_INACTIVE state is configured separately from the UL-PRS configuration used in the RRC_CONNECTED state or the UL-PRS configuration used in the RRC_CONNECTED state is applied to the UL-PRS transmitted by the terminal 20 in the RRC_INACTIVE state is notified from the base station 10 by RRC/MAC-CE/DCI. In this example, the notification is performed by RRC.

In S301, the terminal 20 receives the notification from the base station 10 by RRC. In S302, the terminal 20 determines an UL-PRS configuration to be applied based on the received information.

For example, in a case where the terminal 20 receives a notification of “applying an UL-PRS configuration used in an RRC_CONNECTED state” in RRC, when the terminal 20 receives the configuration information of the UL-PRS used in the RRC_CONNECTED state from the base station 10, the terminal 20 transmits the UL-PRS in the RRC_CONNECTED state and transmits the UL-PRS in the RRC_INACTIVE state based on the configuration information.

According to the Example 1-2, the terminal 20 can grasp whether or not an UL-PRS transmitted in an RRC_INACTIVE state is configured separately from an UL-PRS configuration used in an RRC_CONNECTED state.

### Example 2

Next, Example 2 will be described. In the Example 2, in a case where the terminal 20 uses a PRACH preamble as an UL-PRS transmitted in an RRC_INACTIVE state, the terminal 20 assumes that PRACH parameters different from those of PRACH transmitted in an RRC_CONNECTED state is configured.

According to the Example 2, it is possible to apply PRACH preamble parameters flexibly. The target of the Example 2 may be an UL-PRS other than the PRACH preamble. Examples 2-1 and 2-2 will be described below as more specific examples.

### Example 2-1

For example, the number of PRBs for a PRACH preamble as an UL-PRS transmitted in an RRC_INACTIVE state may be defined in the specification, or may be indicated (configured/updated/indicated) from the base station 10 to the terminal 20 by RRC/MAC-CE/DCI.

For example, for a PRACH preamble as an UL-PRS transmitted in an RRC_INACTIVE state, a broadband PRACH (Long sequence PRACH preamble format) for NR-U may be defined in the specification, or may be instructed (configured/updated/indicated) from the base station 10 to the terminal 20 by RRC/MAC-CE/DCI.

Also, for a PRACH preamble as an UL-PRS transmitted in an RRC_INACTIVE state, the number of PRBs may be determined based on an SCS used for PRACH or PUSCH.

Also, for a PRACH preamble as an UL-PRS transmitted in an RRC_INACTIVE state, preamble types (example: collision type, non-collision type) of the PRACH may be defined in the specification or may be instructed (configured/updated/indicated) from the base station 10 to the terminal 20 by RRC/MAC-CE/DCI.

### Example 2-2

For example, transmission power (which may be both the number of PRBs and the transmission power) for a PRACH preamble as an UL-PRS transmitted in an RRC_INACTIVE state may be defined in the specification, or may be instructed (configured/updated/indicated) from the base station 10 to the terminal 20 by RRC/MAC-CE/DCI.

For example, for a PRACH preamble as an UL-PRS transmitted in an RRC_INACTIVE state, a transmission power larger than the transmission power of the PRACH preamble for normal initial access may be defined in the specification so that the preamble reaches a plurality of base stations, or the base station 10 may notify (configure/update/indicate) the terminal 20 of the transmission power by RRC/MAC-CE/DCI.

(Apparatus Configuration)

Next, a functional configuration example of the base station 10 and the terminal 20 for performing the processes and operations described above will be described. The base station 10 and the terminal 20 include all of the functions for implementing the above-described Examples. However, the base station 10 and the terminal 20 may each comprise only the functions of any one of the Examples.

<Base Station 10>

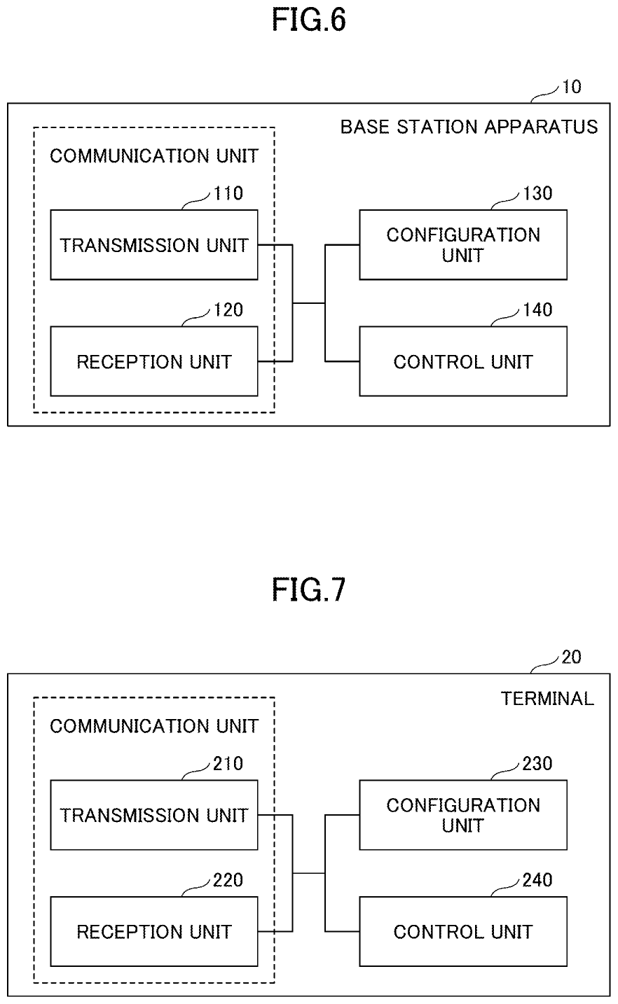

FIG. 6 is a diagram illustrating an example of a functional configuration of the base station 10. As shown in FIG. 6, the base station 10 includes a transmission unit 110, a reception unit 120, a configuration unit 130, and a control unit 140. The functional configuration shown in FIG. 6 is only one example. If the operation according to the embodiments of the present invention can be performed, the function category and the name of the function unit may be any one. The transmission unit 110 and the reception unit 120 may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. The transmission unit 110 has a function to transmit NR-PSS, NR-SSS, NR-PBCH, DL/UL control signals, DL data, and the like to the terminal 20. The transmission unit 110 transmits the configuration information and the like described in Examples 1-2.

The configuration unit 130 stores preconfigured configuration information and various configuration information to be transmitted to the terminal 20 in the storage device and reads the preconfigured configuration information from the storage device if necessary. The control unit 140 performs, for example, resource allocation and control of the entire base station 10. A function unit related to signal transmission in the control unit 140 may be included in the transmission unit 110, and a function unit related to signal reception in the control unit 140 may be included in the reception unit 120. The transmission unit 110 and the reception unit 120 may be called a transmitter and a receiver, respectively. Further, the function of the configuration unit 130 may be included in the control unit 140.

<Terminal 20>

FIG. 7 is a diagram illustrating an example of a functional configuration of the terminal 20. As shown in FIG. 7, the terminal 20 includes a transmission unit 210, a reception unit 220, a configuration unit 230, and a control unit 240. The functional configuration shown in FIG. 7 is only one example. If the operation according to the embodiments of the present invention can be performed, the function category and the name of the function unit may be any one. The transmission unit 210 and the reception unit 220 may be called a communication unit.

The transmission unit 210 creates a transmission signal from the transmission data and wirelessly transmits the transmission signal. The reception unit 220 receives various signals wirelessly and acquires signals from higher layers from the received signal of the physical layer. Further, the reception unit 220 receives the configuration information and the like described in the Examples 2 and 3, and the transmission unit 210 transmits the UL-PRS.

The configuration unit 230 stores various configuration information received from the base station 10 by the reception unit 220 in the storage device and reads it from the storage device as necessary. The configuration unit 230 also stores preconfigured configuration information. The control unit 240 controls the entire terminal 20, and the like. A function unit related to signal transmission in the control unit 240 may be included in the transmission unit 210, and a function unit related to signal reception in the control unit 240 may be included in the reception unit 220. The transmission unit 210 and the reception unit 220 may be called a transmitter and a receiver, respectively. Further, the function of the configuration unit 230 may be included in the control unit 240.

The terminal 20 and the base station 10 are configured as a terminal and a base station described in the following items, for example. In addition, the terminal 20 may perform the following transmission method.

### (Item 1)

A terminal including:
a reception unit configured to receive, from a base station, configuration information on a reference signal of uplink for positioning in a non-connected state; and
a transmission unit configured to transmit the reference signal based on the configuration information in the non-connected state.

### (Item 2)

A terminal including:
a control unit configured to hold configuration information based on a provision on a reference signal of uplink for positioning in a non-connected state; and
a transmission unit configured to transmit the reference signal based on the configuration information in the non-connected state.

### (Item 3)

The terminal as described in item 1 or 2,
wherein the configuration information includes a parameter value that is different from a parameter value to be applied when the reference signal is used in a connected state.

### (Item 4)

The terminal as described in any one of items 1 to 3,
wherein the configuration information is configuration information on a plurality of reference signals, and the transmission unit determines a reference signal to use from the plurality of reference signals based on a frequency or a format of each reference signal in the plurality of reference signals.

### (Item 5)

A base station including:
a transmission unit configured to transmit, to a terminal, configuration information on a reference signal of uplink used for positioning when the terminal is in a non-connected state; and
a reception unit configured to receive the reference signal transmitted from the terminal based on the configuration information when the terminal is in the non-connected state.

### (Item 6)

A transmission method executed by a terminal, including:
receiving, from a base station, configuration information on a reference signal of uplink for positioning in a non-connected state; and
transmitting the reference signal based on the configuration information in the non-connected state.

According to the configuration described in any of the above items, the terminal can transmit the UL signal for positioning in the non-connected state. Also, according to the third term, for example, it is possible to transmit an UL-PRS based on a parameter value suitable for positioning in a non-connected state. According to the fourth item, it is possible to appropriately select a reference signal to be used from a plurality of reference signals.

(Hardware Configuration)

The block diagrams (FIG. 6 and FIG. 7) used in the description of the embodiment described above illustrate the block of functional unit. Such function blocks (configuration parts) are attained by at least one arbitrary combination of hardware and software. In addition, an attainment method of each of the function blocks is not particularly limited. That is, each of the function blocks may be attained by using one apparatus that is physically or logically coupled, by directly or indirectly (for example, in a wired manner, over the radio, or the like) connecting two or more apparatuses that are physically or logically separated and by using such a plurality of apparatuses. The function block may be attained by combining one apparatus described above or a plurality of apparatuses described above with software.

The function includes determining, determining, judging, calculating, computing, processing, deriving, investigating, looking up, ascertaining, receiving, transmitting, output, accessing, resolving, selecting, choosing, establishing, comparing, assuming, expecting, presuming, broadcasting, notifying, communicating, forwarding, configuring, reconfiguring, allocating (mapping), assigning, and the like, but is not limited thereto. For example, a function block (a configuration part) that functions transmission is referred to as the transmitting unit or the transmitter. As described above, the attainment method thereof is not particularly limited.

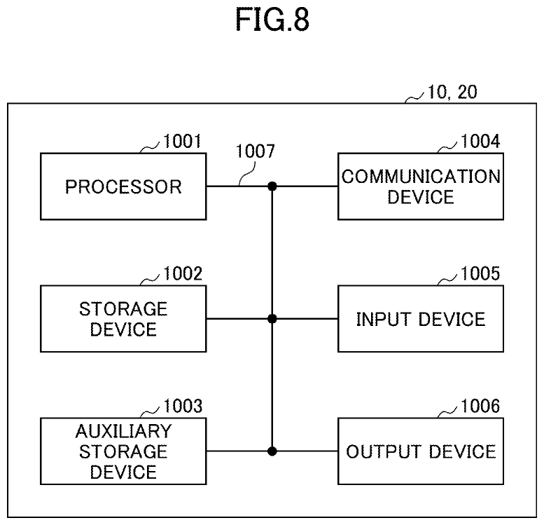

For example, the base station 10, the terminal 20, and the like in one embodiment of this disclosure may function as a computer for performing the processing of a radio communication method of this disclosure. FIG. 8 is a diagram illustrating an example of a hardware configuration of the base station 10 and the terminal 20 according to one embodiment of this disclosure. The base station 10 and the terminal 20 described above may be physically configured as a computer apparatus including a processor 1001, a storage device 1002, an auxiliary storage device 1003, a communication device 1004, an input device 1005, an output device 1006, a bus 1007, and the like.

Note that, in the following description, the word “apparatus” can be replaced with a circuit, a device, a unit, or the like. The hardware configuration of the base station 10 and the terminal 20 may be configured to include one or a plurality of apparatuses illustrated in the drawings, or may be configured not to include a part of the apparatuses.

Each function of the base station 10 and the terminal 20 is attained by reading predetermined software (a program) on hardware such as the processor 1001 and the storage device 1002 such that the processor 1001 performs an operation, and by controlling the communication of the communication device 1004 or by controlling at least one of reading and writing of data in the storage device 1002 and the auxiliary storage device 1003.

The processor 1001, for example, controls the entire computer by operating an operating system. The processor 1001 may be configured by a central processing unit (CPU) including an interface with respect to the peripheral equipment, a control apparatus, an operation apparatus, a register, and the like. For example, the control unit 140, the control unit 240, or the like, described above, may be attained by the processor 1001.

In addition, the processor 1001 reads out a program (a program code), a software module, data, and the like to the storage device 1002 from at least one of the auxiliary storage device 1003 and the communication device 1004, and thus, executes various processing. A program for allowing a computer to execute at least a part of the operation described in the embodiment described above is used as the program. For example, the control unit 140 of the base station 10 illustrated in FIG. 6 may be attained by a control program that is stored in the storage device 1002 and is operated by the processor 1001. In addition, for example, the control unit 240 of the terminal 20 illustrated in FIG. 7 may be attained by a control program that is stored in the storage device 1002 and is operated by the processor 1001. It has been described that the various processing described above are executed by one processor 1001, but the various processing may be simultaneously or sequentially executed by two or more processors 1001. The processor 1001 may be mounted on one or more chips. Note that, the program may be transmitted from a network through an electric communication line.

The storage device 1002 is a computer readable recording medium, and for example, may be configured of at least one of a read only memory (ROM), an erasable programmable ROM (EPROM), an electrically erasable programmable ROM (EEPROM), a random access memory (RAM), and the like. The storage device 1002 may be referred to as a register, a cache, a main memory (a main storage unit), and the like. The storage device 1002 is capable of retaining a program (a program code), a software module, and the like that can be executed in order to implement a communication method according to one embodiment of this disclosure.

The auxiliary storage device 1003 is a computer readable recording medium, and for example, may be configured of at least one of an optical disk such as a compact disc ROM (CD-ROM), a hard disk drive, a flexible disk, a magnetooptical disk (for example, a compact disc, a digital versatile disk, and a Blu-ray (Registered Trademark) disk), a smart card, a flash memory (for example, a card, a stick, a key drive), a floppy (Registered Trademark) disk, a magnetic strip, and the like. The auxiliary storage device 1003 may be referred to as an auxiliary storage unit. The storage medium described above, for example, may be a database including at least one of the storage device 1002 and the auxiliary storage device 1003, a server, and a suitable medium.

The communication device 1004 is hardware (a transmitting and receiving device) for performing communication with respect to the computer through at least one of a wire network and a radio network, and for example, is also referred to as a network device, a network controller, a network card, a communication module, and the like. The communication device 1004, for example, may be configured by including a high frequency switch, a duplexer, a filter, a frequency synthesizer, and the like, in order to attain at least one of frequency division duplex (FDD) and time division duplex (TDD). For example, a transmitting and receiving antenna, an amplifier, a transmitting and receiving unit, a transmission path interface, and the like may be attained by the communication device 1004. In the transmitting and receiving unit, the transmitting unit and the receiving unit are mounted by being physically or logically separated.

The input device 1005 is an input device for receiving input from the outside (for example, a keyboard, a mouse, a microphone, a switch, a button, a sensor, and the like). The output device 1006 is an output device for implementing output with respect to the outside (for example, a display, a speaker, an LED lamp, and the like). Note that, the input device 1005 and the output device 1006 may be integrally configured (for example, a touch panel).

In addition, each of the apparatuses such as the processor 1001 and the storage device 1002 may be connected by the bus 1007 for performing communication with respect to information. The bus 1007 may be configured by using a single bus, or may be configured by using buses different for each of the apparatuses.

In addition, the base station 10 and the terminal 20 may be configured by including hardware such as a microprocessor, a digital signal processor (DSP), an application specific integrated circuit (ASIC), a programmable logic device (PLD), and a field programmable gate array (FPGA), and a part or all of the respective function blocks may be attained by the hardware. For example, the processor 1001 may be mounted by using at least one of the hardware.

### Supplement to Embodiment

As described above, the embodiment of the invention has been described, but the disclosed invention is not limited to the embodiment, and a person skilled in the art will understand various modification examples, correction examples, alternative examples, substitution examples, and the like. Specific numerical examples have been described in order to facilitate the understanding of the invention, but the numerical values are merely an example, and any appropriate values may be used, unless otherwise specified. The classification of the items in the above description is not essential to the invention, and the listings described in two or more items may be used by being combined, as necessary, or the listing described in one item may be applied to the listing described in another item (insofar as there is no contradiction). A boundary between the functional parts or the processing parts in the function block diagram does not necessarily correspond to a boundary between physical components. The operations of a plurality of functional parts may be physically performed by one component, or the operation of one functional part may be physically performed by a plurality of components. In a processing procedure described in the embodiment, a processing order may be changed, insofar as there is no contradiction. For the convenience of describing the processing, the base station 10 and the terminal 20 have been described by using a functional block diagram, but such an apparatus may be attained by hardware, software, or a combination thereof. Each of software that is operated by a processor of the base station 10 according to the embodiment of the invention and software that is operated by a processor of the terminal 20 according to the embodiment of the invention may be retained in a random access memory (RAM), a flash memory, a read only memory (ROM), an EPROM, an EEPROM, a register, a hard disk (HDD), a removable disk, a CD-ROM, a database, a server, and other suitable recording media.

In addition, the notification of the information is not limited to the aspect/embodiment described in this disclosure, and may be performed by using other methods. For example, the notification of the information may be implemented by physical layer signaling (for example, downlink control information (DCI) and uplink control information (UCI)), higher layer signaling (for example, radio resource control (RRC) signaling, medium access control (MAC) signaling, broadcast information (a master information block (MIB)), a system information block (SIB)), other signals, or a combination thereof. In addition, the RRC signaling may be referred to as an RRC message, and for example, may be an RRC connection setup message, an RRC connection reconfiguration message, and the like.

Each aspect/embodiments described in this disclosure may be applied to a system using long term evolution (LTE), LTE-advanced (LTE-A), SUPER 3G, IMT-advanced, a 4th generation mobile communication system (4G), a 5th generation mobile communication system (5G), future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems and a next-generation system that is expanded on the basis thereof. In addition, a combination of a plurality of systems (for example, a combination of at least one of LTE and LTE-A and 5G, and the like) may be applied.

In the processing procedure, the sequence, the flowchart, and the like of each aspect/embodiment described herein, the order may be changed, insofar as there is no contradiction. For example, in the method described in this disclosure, the elements of various steps are presented by using an exemplary order, but are not limited to the presented specific order.

Here, a specific operation that is performed by the base station 10 may be performed by an upper node, in accordance with a case. In a network provided with one or a plurality of network nodes including the base station 10, it is obvious that various operations that are performed in order for communication with respect to the terminal 20 can be performed by at least one of the base station 10 and network nodes other than the base station 10 (for example, MME, S-GW, or the like is considered as the network node, but the network node is not limited thereto). In the above description, a case is exemplified in which the number of network nodes other than the base station 10 is 1, but a plurality of other network nodes may be combined (for example, the MME and the S-GW).

The information, the signal, or the like described in this disclosure can be output to a lower layer (or the higher layer) from the higher layer (or the lower layer). The information, the signal, or the like may be input and output through a plurality of network nodes.

The information or the like that is input and output may be retained in a specific location (for example, a memory), or may be managed by using a management table. The information or the like that is input and output can be subjected to overwriting, updating, or editing. The information or the like that is output may be deleted. The information or the like that is input may be transmitted to the other apparatuses.

Judgment in this disclosure may be performed by a value represented by 1 bit (0 or 1), may be performed by a truth-value (Boolean: true or false), or may be performed by a numerical comparison (for example, a comparison with a predetermined value).

Regardless of whether the software is referred to as software, firmware, middleware, a microcode, and a hardware description language, or is referred to as other names, the software should be broadly interpreted to indicate a command, a command set, a code, a code segment, a program code, a program, a sub-program, a software module, an application, a software application, a software package, a routine, a sub-routine, an object, an executable file, an execution thread, a procedure, a function, and the like.

In addition, software, a command, information, and the like may be transmitted and received through a transmission medium. For example, in a case where the software is transmitted from a website, a server, or other remote sources by using at least one of a wire technology (a coaxial cable, an optical fiber cable, a twisted pair, a digital subscriber line (DSL), and the like) and a radio technology (an infrared ray, a microwave, and the like), at least one of the wire technology and the radio technology is included in the definition of the transmission medium.

The information, the signal, and the like described in this disclosure may be represented by using any of various different technologies. For example, the data, the command, the command, the information, the signal, the bit, the symbol, the chip, and the like that can be referred to through the entire description described above may be represented by a voltage, a current, an electromagnetic wave, a magnetic field or magnetic particles, an optical field or a photon, or an arbitrary combination thereof.

Note that, the terms described in this disclosure and the terms necessary for understanding this disclosure may be replaced with terms having the same or similar meaning. For example, at least one of the channel and the symbol may be a signal (signaling). In addition, the signal may be a message. In addition, a component carrier (CC) may be referred to as a carrier frequency, a cell, a frequency carrier, and the like.

The terms “system” and “network” used in this disclosure are interchangeably used.

In addition, the information, the parameter, and the like described in this disclosure may be represented by using an absolute value, may be represented by using a relative value from a predetermined value, or may be represented by using another corresponding information. For example, a radio resource may be indicated by an index.

The names used in the parameters described above are not a limited name in any respect. Further, expressions or the like using such parameters may be different from those explicitly disclosed in this disclosure. Various channels (for example, PUSCH, PUCCH, PDCCH, and the like) and information elements can be identified by any suitable name, and thus, various names that are allocated to such various channels and information elements are not a limited name in any respect.

In this disclosure, the terms “base station (BS)”, “radio base station”, “base station”, “fixed station”, “NodeB”, “eNodeB (eNB)”, “gNodeB (gNB)”, “access point”, “transmission point”, “reception point”, “transmission and reception point”, “cell”, “sector”, “cell group”, “carrier”, “component carrier”, and the like can be interchangeably used. The base station may be referred to by a term such as a macro-cell, a small cell, a femtocell, and a picocell.

The base station is capable of accommodating one or a plurality of (for example, three) cells. In a case where the base station accommodates a plurality of cells, the entire coverage area of the base station can be classified into a plurality of small areas, and each of the small areas is capable of providing communication service by a base station sub-system (for example, an indoor type small base station (a remote radio head (RRH)). The term “cell” or “sector” indicates a part of the coverage area or the entire coverage area of at least one of the base station and the base station sub-system that perform the communication service in the coverage.

In this disclosure, the terms “mobile station (MS)”, “user terminal”, “user equipment (UE)”, and “terminal” can be interchangeably used.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a terminal, a wireless terminal, a remote terminal, a handset, a user agent, a mobile client, a client, or other suitable terms, by a person skilled in the art.

At least one of the base station and the mobile station may be referred to as a transmitting apparatus, a receiving apparatus, a communication apparatus, and the like. Note that, at least one of the base station and the mobile station may be a device that is mounted on a mobile object, the mobile object itself, or the like. The mobile object may be a vehicle (for example, a car, an airplane, and the like), may be a mobile object that is moved in an unmanned state (for example, a drone, an autonomous driving car, and the like), or may be a (manned or unmanned) robot. Note that, at least one of the base station and the mobile station also includes an apparatus that is not necessarily moved at the time of a communication operation. For example, at least one of the base station and the mobile station may be an internet of things (IoT) device such as a sensor.

In addition, the base station in this disclosure may be replaced with the terminal. For example, each aspect/embodiment of this disclosure may be applied to a configuration in which communication between the base station and the terminal is replaced with communication in a plurality of terminals 20 (for example, may be referred to as device-to-device (D2D), vehicle-to-everything (V2X), and the like). In this case, the function of the base station 10 described above may be provided in the terminal 20. In addition, the words “uplink”, “downlink”, and the like may be replaced with words corresponding to the communication between the terminals (for example, “side”). For example, an uplink channel, a downlink channel, and the like may be replaced with a side channel.

Similarly, the terminal in this disclosure may be replaced with the base station. In this case, the function of the user terminal described above may be provided in the base station.

The terms “determining” and “determining” used in this disclosure may involve diverse operations. “Determining” and “determining”, for example, may include deeming judging, calculating, computing, processing, deriving, investigating, looking up (search, inquiry) (for example, looking up in a table, a database, or another data structure), and ascertaining, as “determining” and “determining”. In addition, “determining” and “determining” may include deeming receiving (for example, receiving information), transmitting (for example, transmitting information), input, output, and accessing (for example, accessing data in a memory), as “determining” and “determining”. In addition, “determining” and “determining” may include deeming resolving, selecting, choosing, establishing, comparing, and the like as “determining” and “determining”. That is, “determining” and “determining” may include deeming an operation as “determining” and “determining”. In addition, “determining (determining)” may be replaced with “assuming”, “expecting”, “considering”, and the like.

The terms “connected” and “coupled”, or any modification thereof indicate any direct or indirect connection or couple in two or more elements, and are capable of including a case where there are one or more intermediate elements between two elements that are “connected” or “coupled” to each other. The couple or connection between the elements may be physical or logical, or may be a combination thereof. For example, the “connection” may be replaced with “access”. In the case of being used in this disclosure, it is possible to consider that two elements are “connected” or “coupled” to each other by using at least one of one or more electric wires, cables, and print electric connection, and as some non-limiting and non-inclusive examples, by using electromagnetic energy having a wavelength of a radio frequency domain, a microwave domain, and an optical (visible and invisible) domain, and the like.

The reference signal can also be abbreviated as RS, and may be referred to as pilot on the basis of a standard to be applied.

The description “on the basis of” that is used in this disclosure does not indicate “only on the basis of”, unless otherwise specified. In other words, the description “on the basis of” indicates both “only on the basis of” and “at least on the basis of”.

Any reference to elements using the designations “first,” “second,” and the like, used in this disclosure, does not generally limit the amount or the order of such elements. Such designations can be used in this disclosure as a convenient method for discriminating two or more elements. Therefore, a reference to a first element and a second element does not indicate that only two elements can be adopted or the first element necessarily precedes the second element in any manner.

“Means” in the configuration of each of the apparatuses described above may be replaced with “unit”, “circuit”, “device”, and the like.

In this disclosure, in a case where “include”, “including”, and the modification thereof are used, such terms are intended to be inclusive, as with the term “comprising”. Further, the term “or” that is used in this disclosure is not intended to be exclusive-OR.

A radio frame may be configured of one or a plurality of frames in a time domain. Each of one or a plurality of frames in the time domain may be referred to as a subframe. The subframe may be further configured of one or a plurality of slots in the time domain. The subframe may be a fixed time length (for example, 1 ms) that does not depend on numerology.

The numerology may be a communication parameter to be applied to at least one of the transmission and the reception of a certain signal or channel. The numerology, for example, may indicate at least one of subcarrier spacing (SCS), a bandwidth, a symbol length, a cyclic prefix length, a transmission time interval (TTI), the number of symbols per TTI, a radio frame configuration, specific filtering processing that is performed by the transceiver in a frequency domain, specific windowing processing that is performed by the transceiver in a time domain, and the like.

The slot may be configured of one or a plurality of symbols (an orthogonal frequency division multiplexing (OFDM) symbol, a single carrier frequency division multiple access (SC-FDMA) symbol, and the like) in a time domain. The slot may be time unit based on the numerology.

The slot may include a plurality of mini slots. Each of the mini slots may be configured of one or a plurality of symbols in the time domain. In addition, the mini slot may be referred to as a subslot. The mini slot may be configured of symbols of which the number is less than that of the slot. PDSCH (or PUSCH) to be transmitted in time unit greater than the mini slot may be referred to as a PDSCH (or PUSCH) mapping type A. PDSCH (or PUSCH) to be transmitted by using the mini slot may be referred to as a PDSCH (or PUSCH) mapping type B.

All of the radio frame, the subframe, the slot, the mini slot, and the symbol represent time unit at the time of transmitting a signal. Other names respectively corresponding to the radio frame, the subframe, the slot, the mini slot, and the symbol may be used.

For example, one subframe may be referred to as a transmission time interval (TTI), a plurality of consecutive subframes may be referred to as TTI, or one slot or one mini slot may be referred to as TTI. That is, at least one of the subframe and TTI may be a subframe (1 ms) in the existing LTE, may be a period shorter than 1 ms (for example, 1 to 13 symbols), or may be a period longer than 1 ms. Note that, unit representing TTI may be referred to as a slot, a mini slot, and the like, but not a subframe.

Here, TTI, for example, indicates minimum time unit of scheduling in radio communication. For example, in an LTE system, the base station performs scheduling for allocating a radio resource (a frequency bandwidth, transmission power, and the like that can be used in each of the terminals 20) in TTI unit, with respect to each of the terminals 20. Note that, the definition of TTI is not limited thereto.

TTI may be a transmission time unit of a data packet (a transport block), a code block, a codeword, and the like that are subjected to channel coding, or may be processing unit of scheduling, link adaptation, and the like. Note that, when TTI is applied, a time section (for example, the number of symbols) in which the transport block, the code block, the codeword, and the like are actually mapped may be shorter than TTI.

Note that, in a case where one slot or one mini slot is referred to as TTI, one or more TTIs (that is, one or more slots or one or more mini slots) may be the minimum time unit of the scheduling. In addition, the number of slots (the number of mini slots) configuring the minimum time unit of the scheduling may be controlled.

TTI having a time length of 1 ms may be referred to as a normal TTI (TTI in LTE Rel.8-12), a normal TTI, a long TTI, a normal subframe, a normal subframe, a long subframe, a slot, and the like. TTI shorter than the normal TTI may be referred to as a shortened TTI, a short TTI, a partial TTI (or a fractional TTI), a shortened subframe, a short subframe, a mini slot, a subslot, a slot, and the like.

Note that, the long TTI (for example, the normal TTI, the subframe, and the like) may be replaced with TTI having a time length of greater than or equal to 1 ms, and the short TTI (for example, the shortened TTI and the like) may be replaced with TTI having a TTI length of less than a TTI length of the long TTI and greater than or equal to 1 ms.

The resource block (RB) is a resource allocation unit of the time domain and the frequency domain, and may include one or a plurality of consecutive subcarriers in the frequency domain. The number of subcarriers included in RB may be the same regardless of the numerology, or for example, may be 12. The number of subcarriers included in RB may be determined on the basis of the numerology.

In addition, the time domain of RB may include one or a plurality of symbols, or may be the length of one slot, one mini slot, one subframe, or one TTI. One TTI, one subframe, and the like may be respectively configured of one or a plurality of resource blocks.

Note that, one or a plurality of RBs may be referred to as a physical resource block (physical RB: PRB), a sub-carrier group (SCG), a resource element group (REG), a PRB pair, a RB pair, and the like.

In addition, the resource block may be configured of one or a plurality of resource elements (RE). For example, one RE may be a radio resource domain of one subcarrier and one symbol.

A bandwidth part (BWP) (may be referred to as a part bandwidth or the like) may represent a subset of consecutive common resource blocks (common RBs) for certain numerology, in a certain carrier. Here, the common RB may be specified by an index of RB based on a common reference point of the carrier. PRB may be defined by a certain BWP, and may be numbered within BWP.

BWP may include BWP for UL (UL BWP) and BWP for DL (DL BWP). In UE, one or a plurality of BWPs may be configured within one carrier.

At least one of the configured BWPs may be active, and it may not be assumed that the UE transmits and receives a predetermined signal/channel out of the active BWP. Note that, the “cell”, the “carrier”, and the like in this disclosure may be replaced with “BWP”.

The structure of the radio frame, the subframe, the slot, the mini slot, the symbol, and the like, described above, is merely an example. For example, the configuration of the number of subframes included in the radio frame, the number of slots per a subframe or a radio frame, the number of mini slots included in the slot, the number of symbols and RBs included in the slot or a mini slot, the number of subcarriers included in RB, the number of symbols in TTI, a symbol length, a cyclic prefix (CP) length, and the like can be variously changed.

In this disclosure, for example, in a case where articles such as a, an, and the are added by translation, this disclosure may include a case where nouns following the articles are in the plural.

In this disclosure, the term “A and B are different” may indicate “A and B are different from each other”. Note that, the term may indicate “A and B are respectively different from C”. The terms “separated”, “coupled”, and the like may be interpreted as with “being different”.

Each aspect/embodiment described in this disclosure may be independently used, may be used by being combined, or may be used by being switched in accordance with execution. In addition, the notification of predetermined information (for example, the notification of “being X”) is not limited to being performed explicitly, and may be performed implicitly (for example, the notification of the predetermined information is not performed).

In the present disclosure, the SS block or CSI-RS is an example of a synchronization signal or reference signal.

As described above, this disclosure has been described in detail, but it is obvious for a person skilled in the art that this disclosure is not limited to the embodiment described in this disclosure. This disclosure can be implemented as corrected and changed modes without departing from the spirit and scope of this disclosure defined by the description of the claims. Therefore, the description in this disclosure is for illustrative purposes and does not have any limiting meaning with respect to this disclosure.

### DESCRIPTION OF SYMBOLS

10 base station
110 transmission unit
120 reception unit
130 configuration unit
140 control unit
20 terminal
210 transmission unit
220 reception unit
230 configuration unit
240 control unit
1001 processor
1002 storage device
1003 auxiliary storage device
1004 communication device
1005 input device
1006 output device

1. A terminal comprising:
a reception unit configured to receive, from a base station, configuration information on a reference signal of uplink for positioning in a non-connected state; and
a transmission unit configured to transmit the reference signal based on the configuration information in the non-connected state.

2. A terminal comprising:
a control unit configured to hold configuration information based on a provision on a reference signal of uplink for positioning in a non-connected state; and
a transmission unit configured to transmit the reference signal based on the configuration information in the non-connected state.

3. The terminal as claimed in claim 1, wherein the configuration information includes a parameter value that is different from a parameter value to be applied when the reference signal is used in a connected state.

4. The terminal as claimed in claim 1, wherein the configuration information is configuration information on a plurality of reference signals, and the transmission unit determines a reference signal to use from the plurality of reference signals based on a frequency or a format of each reference signal in the plurality of reference signals.

5. A base station comprising:
a transmission unit configured to transmit, to a terminal, configuration information on a reference signal of uplink used for positioning when the terminal is in a non-connected state; and
a reception unit configured to receive the reference signal transmitted from the terminal based on the configuration information when the terminal is in the non-connected state.

6. A transmission method executed by a terminal, comprising:
receiving, from a base station, configuration information on a reference signal of uplink for positioning in a non-connected state; and
transmitting the reference signal based on the configuration information in the non-connected state.

7. The terminal as claimed in claim 2, wherein the configuration information includes a parameter value that is different from a parameter value to be applied when the reference signal is used in a connected state.

8. The terminal as claimed in claim 2, wherein the configuration information is configuration information on a plurality of reference signals, and the transmission unit determines a reference signal to use from the plurality of reference signals based on a frequency or a format of each reference signal in the plurality of reference signals.

9. The terminal as claimed in claim 3, wherein the configuration information is configuration information on a plurality of reference signals, and the transmission unit determines a reference signal to use from the plurality of reference signals based on a frequency or a format of each reference signal in the plurality of reference signals.
